(19) United States
(12) Patent Application Publication
(10) Pub. No.: US 2009/0303344 A1
(43) Pub. Date: Dec. 10, 2009

(54) RECORDING MIDIUM OF DIGITAL PHOTO FILE AND METHOD OF GENERATING DIGITAL PHOTO FILE

(75) Inventor: Te-Yu KAO, Jhubei City (TW)

Correspondence Address: APEX JURIS, PLLC, 12733 LAKE CITY WAY NORTHEAST, SEATTLE, WA, 98125, US

(73) Assignee: ALTEK CORPORATION, Hsinchu (TW)

(21) Appl. No.: 12/420,624

(22) Filed: Apr. 8, 2009

(30) Foreign Application Priority Data
Jun. 4, 2008 (TW) 097120764

(51) Int. Cl. H04N 9/73; H04N 5/76

(52) U.S. Cl. 348/223.1; 348/231.7; 348/E09.051

(57) ABSTRACT

A recording medium of a digital photo file and a method of generating a digital photo file are presented. An electronic device generates several pieces of thumbnails with different uses according to a content of a photo data, and embeds the thumbnails in a single image file, thereby forming the digital photo file. The digital photo file is characterized in that several pieces of photo contents with different uses are included in the same file, for photo printing, computer photo editing, photo rapid previewing, and playing in an electronic apparatus with an excellent photo quality and browsing speed.

### CROSS-REFERENCE TO RELATED APPLICATIONS

This non-provisional application claims priority under 35 U.S.C. §119(a) on Patent Application No(s). 097120764 filed in Taiwan, R.O.C. on Jun. 4, 2008 the entire contents of which are hereby incorporated by reference.

### BACKGROUND OF THE INVENTION

1. Field of Invention

The present invention relates to a method of generating a digital photo file, and more particularly to a method of generating a digital photo file in which several pieces of photo contents are generated and embedded in a single image file.

2. Related Art

Along with the progress of the digital camera technology, digital photo files have increasingly higher resolution. In order to display a composition and a general effect of an original photo on a handheld device rapidly, some commercially available digital cameras embed a thumbnail within an original photo file when generating a digital photo, so as to preview the composition of the photo rapidly.

The thumbnail appended to the digital photo file is basically a reduced photo of the original one, which has a format with a general use, and does not make an adjustment to a character of color and brightness display of a liquid crystal display (LCD) on the handheld device, so that a disagreement of the brightness and color display occurs between visual images generated when previewing the thumbnail rapidly and when looking at the photo ultimately. Although the photo can be corrected by utilizing a converting procedure in this case to solve the disagreement of the brightness and color display, it consumes a hardware operating resource, takes time to make correction, thereby loosing a goodwill of browsing the original thumbnail simply and rapidly. For example, in the handheld electronic device (e.g., a digital photo-frame) with a great size of screen, the thumbnail information generated by the digital camera may not be suitable for browsing due to its too low resolution. It takes too many operating time to read the original photo, and even if a photo correction is performed to the thumbnail by hardware operation, it also takes time to wait for performing the converting procedure, which is quite inconvenient for a user.

### SUMMARY OF THE INVENTION

In view of the above problems, the present invention is mainly directed to a photo file format with several pieces of thumbnail embedded therein and capable of having a high quality photo and rapid display effect on various different liquid crystal panels. The photo file format includes an original photo data segment taken by a user and a first thumbnail data segment, as well as a second thumbnail data segment. A content of the first thumbnail data segment is a reduced version of a content of the original photo, while the second thumbnail data segment is a version after the content of the original photo has been adjusted according to display parameters, for being read in a dedicated display device.

Accordingly, in order to generate the above photo file format, the present invention provides a method of generating a digital photo file, which includes obtaining a source data, generating an original photo data according to the source data, generating a first thumbnail data with a lower resolution according to the source data, adjusting a content of the digital photo with a display parameter to obtain a second thumbnail data according to the source data;, and combining the source data, the first thumbnail data, and the second thumbnail data into a digital photo file.

The present invention is characterized in that the second thumbnail data is embedded in the photo file taken by the user, the second thumbnail data is generated by adjusting the content of the photo according to characters of a liquid crystal screen (such as a color gamut character of three primary colors, gamma, and arranging pattern) of a special handheld device. This approach can make the content of the photo to be reproduced on the liquid crystal screen of the handheld device simply. The present invention is particularly suitable to be used on a digital camera, an electronic album, a camera cell phone, and any other digital electronic apparatus having a digital photo display function.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating an embodiment of the present invention;

FIG. 2 is a schematic view illustrating an embodiment of the present invention; and

FIG. 3 is a flow chart of a method of generating a digital photo file according to an embodiment of the present invention.

### DETAILED DESCRIPTION OF THE INVENTION

A purpose of the present invention and an implementation thereof are illustrated in the following preferred embodiments. However, the concept of the present invention is also applicable to other range. The embodiments below are only described for illustrating the purpose of the present invention and the implementation thereof, instead of limiting the scope of the present invention.

In the following illustration, an exchangeable image file format (EXIF) refers to a data format which is set exclusively for a photo taken by a digital camera. It can be easily understood by those skilled in the art that the EXIF information is mainly used to record an extra attribute message and shot information of a digital photo, and the EXIF information can be appended into files such as JPEG, TIFF, and RIFF, so that a manufacturer can add contents (e.g., aperture, shutter, sensitivity, and date) related to a shot message of the digital camera, an index diagram, or any customized data format, into a digital photo file.

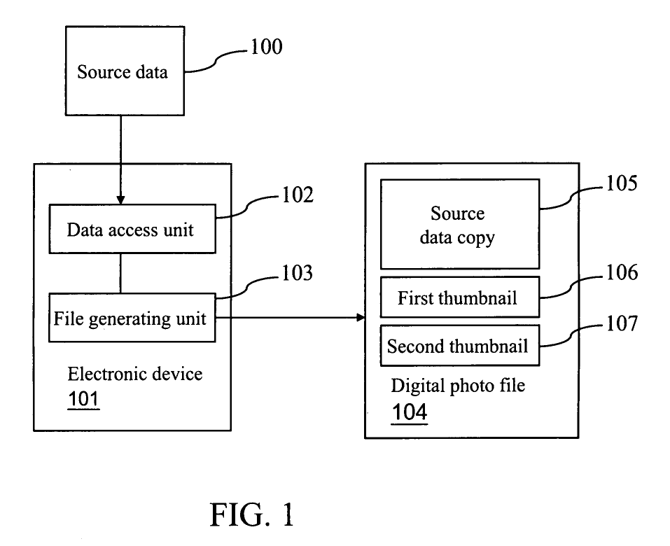

FIG. 1 is a schematic view of implementing a method of generating a digital photo file according to an embodiment of the present invention. Referring to FIG. 1, an electronic device 101 implementing a method of generating a digital photo file according to the present invention firstly utilizes a data access unit 102 to read a source data 100. Then, a file generating unit 103 generates a digital photo source data copy 105according to a content of the source data 100, and generates a first thumbnail 106 after reducing a resolution of the digital photo source data copy 105. Thereafter, the file generating unit 103 generates a second thumbnail 107 after adjusting the resolution, brightness, contrast, and white balance of the digital photo source data copy 105 according to a photo editing parameter preset by a manufacturer, and finally combines the digital photo source data copy 105, the first thumbnail 106, and the second thumbnail 107 into a digital photo file 104.

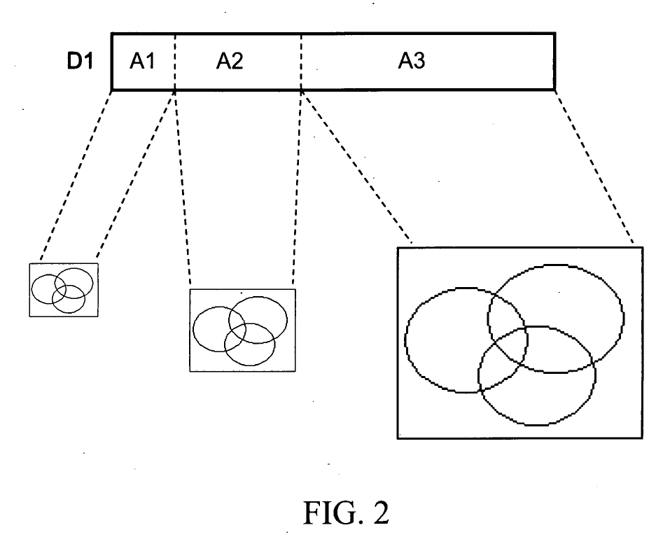

FIG. 2 is a diagram illustrating a recording medium of a digital photo file according to an embodiment of the present invention. For the sake of simplifying the illustration, the detailed description of the present invention is illustrated by taking a piece of digital image of 1600×1200 pixels taken by a digital camera as an example. Referring to FIG. 2, when a user takes photos, the digital camera generates a digital photo file D1. According to the present invention, three data segments recording three pieces of image data respectively are included in the digital photo file D1. The three pieces of image data are respectively an original photo data A3 (having the lower resolution of 1600×1200), which is stored in the file according to a full resolution when being taken, a first thumbnail data A1 (having the lower resolution of 160×120), which is a version after the resolution of the original photo data A3 has been reduced, and a second thumbnail data A2 (having the lower resolution of 320×240), which is a version after a content of the original photo data A3 has been adjusted according to the resolution, brightness, contrast, and white balance according to the brightness and contrast of a liquid crystal display panel.

As described above, the digital photo file D1 records the original photo data A3 (i.e., the original photo data A3 with full resolution), and further includes the first thumbnail data A1 and the second thumbnail data A2. From the view point of function, the original photo data A3 has a high resolution suitable for photo printing or performing an image processing by a computer. The first thumbnail data A1 has a low resolution and small amount of the data, and is applied to be used on general photo software for rapid previewing. Since the lower resolution A1 is lower, a difference (e.g., color difference) may exist between the original photo data and a visual image when browsing. As a result, the second thumbnail data A2 is designed to enable the user enjoying a preferred playing effect on different display apparatus. Suitable screen correction adjustments have been made to the second thumbnail data A2 according to the resolution, brightness, contrast, and white balance. Therefore, for the different display apparatus, the second thumbnail data A2 has advantages of a high display quality and a rapid browsing speed all together.

In the actual applications, the user can store the above mentioned digital photo file in a memory card, such as SD, XD, CF, MS, and MMC, and the memory card is used on a dedicated apparatus. In this way, the apparatus firstly determines whether the photo file is the dedicated file format when reading the photo file, and directly reads the second thumbnail data for playing instead of reading all data of the whole photo file, thereby obtaining a preferred display effect and a rapid photo browsing speed. In other embodiments, it is designed to embed several pieces of the second thumbnail data A2 in the digital photo file D1, so as to support many kinds of display apparatus with different resolutions. A number of the second thumbnail data A2 embedded in the digital photo file D1 is not limited herein.

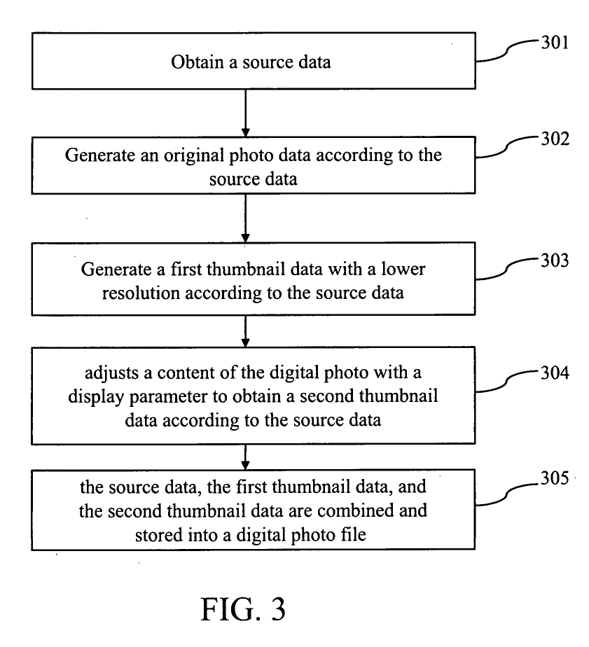

FIG. 3 is a flow chart of a method of generating a digital photo file according to an embodiment of the present invention. For the sake of simplifying the illustration, the detailed description of the present invention is illustrated subsequently by taking applying the method to a camera cell phone as an example.

Referring to FIG. 3, according to a method of generating a digital photo file of the present invention, firstly, a user utilizes a camera cell phone to take photos, thereby recording a segment of source data (Step 301). Then, the camera cell phone generates an original photo data according to the source data (Step 302); generates a first thumbnail data with a lower resolution (Step 303); and adjusts a content of the digital photo with a display parameter to obtain a second thumbnail data according to the source data (Step 304). Finally, the source data, the first thumbnail data, and the second thumbnail data are combined and stored into a digital photo file (Step 305).

The above method is characterized in that the second thumbnail data is a photo whose content has been adjusted according to the display parameter of a display panel. In other words, the second thumbnail undergoes a trimming on the resolution, brightness, contrast or white balance of the shot content according to a screen character of electronic apparatus (e.g., a camera cell phone). Accordingly, when browsing the photo by these electronic apparatus, an excellent display quality and browsing speed will be obtained. In actual applications, the display parameter can be some color adjustment values set according to display apparatus with screens of different sizes, so as to perform a color compensation of a screen correction on the photo. For example, some manufacturers sell a series of products with different screen sizes, such as digital cameras, camera cell phones, and electronic albums. Although the screens of the electronic apparatus are different in contrast, brightness and resolution, the manufacturers may enable the user choose freely to output any kind of dedicated photo file used by a screen from a corresponding display parameter database preset according to various screens.

For this embodiment, if the manufacturer sets corresponding display parameters for a series of electronic apparatus with display screens of different sizes, and installs the corresponding display parameters on a camera cell phone, the camera cell phone can not only generate a dedicated photo file used by its screen, but generate a dedicated thumbnail used by screens of different sizes, for displaying on various display apparatus. Common JPEG, TIFF photo file formats can be embedded in the EXIF information customized by the manufacturers themselves. By utilizing such a character, the present invention also embeds the first thumbnail data and the second thumbnail data in the photo file, so as to generate a digital photo file with a general and special uses all together. The digital photo files are applicable to general electronic apparatus with a liquid crystal screen, such as a cell phone, a PDA, an electronic album, and a digital photo-frame. The resolution of the second thumbnail can be 640×480, 320×240, 160×120 or any size, depending on different screen sizes, characters of the apparatus. On the other hand, a photo color of the second thumbnail can also be adjusted differently depending on an attribute of each screen.

A device performing the method of generating the digital photo file can be general electronic apparatus, and a physical apparatus performing the generating method is not limited herein. In this embodiment, the device includes a data reading unit, a photo file generating unit, and a storage unit. The data reading unit is used for accessing to a source data. The photo file generating unit is used for generating an original photo data, a thumbnail data, and a second thumbnail data according to the source data. The thumbnail data is a reduced version of the content of the original photo, and the second thumbnail data is a version after the content of the original photo has been adjusted according to a display parameter of a special display panel. The storage unit is used for combining the source data, the first thumbnail data, and the second thumbnail data into a digital photo file.

Accordingly, the device can be a processing unit which performs an application or an embedded firmware. The processing unit can be a processor or chip in any form. After a device equipped with sufficient memory units preloads the photo data, the photo file generating unit of the device generates the first thumbnail with a lower resolution according to the loaded photo data. Then, the device adjusts the display parameter, such as the brightness, contrast, and white balance, of the loaded photo according to a screen attribute of a specific type, so as to generate the second thumbnail after the screen correction. Thereafter, the device combines the source data, the first thumbnail, and the second thumbnail into a single digital photo file. Therefore, a multifunctional digital photo file applicable for printing, rapid previewing, and playing on the special electronic apparatus with a high quality all together can be generated.

What is claimed is:

1. A method of generating a digital photo file, applied to an electronic device, the method comprising:
loading a source data of at least one digital photo;
generating a first thumbnail data with a lower resolution than an original resolution according to the source data;
adjusting a content of the digital photo with a display parameter to obtain a second thumbnail data according to the source data; and
combining the source data, the first thumbnail data, and the second thumbnail data into a digital photo file.
The method of generating a digital photo file according to claim 1, wherein the lower resolution is any one selected from the group consisting of 160×120, 80×60, 40×30.

2. The method of generating a digital photo file according to claim 1, wherein a resolution of the second thumbnail data is any one selected from the group consisting of 640×480, 320×240.

3. The method of generating a digital photo file according to claim 1, wherein the display parameter is a color adjustment parameter used to perform screen correction of the content of the digital photo according to a display screen.

4. The method of generating a digital photo file according to claim 1, wherein the display parameter is any one selected from the group consisting of resolution, brightness, contrast, and white balance.

5. The method of generating a digital photo file according to claim 1, wherein the electronic device is any one selected from the group consisting of a digital camera, a camera cell phone, an electronic album.

6. The method of generating a digital photo file according to claim 1, wherein the first thumbnail data and the second thumbnail data are stored in the digital photo file in an EXIF (Exchangeable image file format) data format.

7. A recording medium of recording a digital photo file, applied to be read by an electronic display device, wherein:
a format of a recorded digital photo file comprises:
a digital photo data segment of a digital photo content, a first thumbnail data segment, and a second thumbnail data segment, wherein the first thumbnail data segment is a copy of a lower resolution than the digital photo data segment with a full resolution, and the second thumbnail data segment is other copy of the digital photo content has been adjusted according to a display parameter.

8. The recording medium of recording a digital photo file according to claim 8, wherein the display parameter is a color adjustment parameter used to perform screen correction on the content of the digital photo according to a display screen.

9. The recording medium of recording a digital photo file according to claim 8, wherein the display parameter is any one selected from the group consisting of resolution, brightness, contrast, and white balance.

10. The recording medium of recording a digital photo file according to claim 8, wherein the electronic device is any one selected from the group consisting of a digital camera, a camera cell phone, and an electronic album.

11. The recording medium of recording a digital photo file according to claim 8, wherein the first thumbnail data and the second thumbnail data are stored in the digital photo file in an EXIF data format.

12. The recording medium of recording a digital photo file according to claim 8, wherein the recording medium is a memory card, and the memory card is any one selected from the group consisting of memory cards such as SD, XD, CF, MS, and MMC.
